(19) United States
(12) Patent Application Publication
(10) Pub. No.: US 2018/0309509 A1
(43) Pub. Date: Oct. 25, 2018

(54) USER GROUPING METHOD AND BASE STATION USING THE SAME

(71) Applicant: NATIONAL CHUNG CHENG UNIVERSITY, Min-Hsiung (TW)

(72) Inventor: Wern-Ho SHEEN, CHIA-YI COUNTY (TW)

(21) Appl. No.: 15/626,792

(22) Filed: Jun. 19, 2017

(30) Foreign Application Priority Data
Apr. 25, 2017 (TW) 106113783

(51) Int. Cl. H04B 7/204; H04W 4/08; H04W 72/08; H04B 17/345

(52) U.S. Cl. CPC H04B 7/204; H04W 4/08; H04B 7/0452; H04B 17/345; H04W 72/08

(57) ABSTRACT

A user grouping method and a base station are provided, which is adapted for the base station providing services to multiple user equipments (UEs) through multiple beams. The user group method includes the following stage. In the first stage, whether beams used by the UEs are interfered with others is determined according to channel information of the UEs on each of the beams. The UEs having beams interfered with the others are assigned into same group to mitigate interference. Then, in the second stage, numbers of users and used beams in oversized groups are reduced. In the third stage, undersized groups are combined. Accordingly, computational complexity is reduced and system performance is improved.

### BACKGROUND OF THE DISCLOSURE

### 1. Field of the Disclosure

The present disclosure relates generally to Beam-group Division Multiple Access (BgDMA) communications, and more particularly, to a user grouping method and a base station using the same.

### 2. Description of the Related Art

Industry and academia around the world have been focusing on the development of fifth-generation (5G) mobile communication system for many years. Among different technologies, the large-scale antenna technology is one of the most critical enablers for 5G system to achieve the performance requirements set forth by ITUR, where a base station can provide service to lots of users using the large-scale antenna at same time. However, there are some technical challenges facing the existing large-scale antenna technology: for example, (1) if performing signal processing per antenna-channel, lots of pilot signals would be needed for channel estimation, and the channel having high frequency selective characteristic may affect the system performance; (2) the complexity for high-order multiple user multiple input multiple output (MU-MIMO) may raise greatly.

Among lots of large-scale antenna technologies, Beam-group Division Multiple Access (BgDMA) system is proposed to solve the aforementioned problem. In BgDMA system, signal processing would be performed on the beam domain, so as to solve frequency selectivity, and the pilot signal density and the number of channel for estimation would be reduced greatly. In addition, when using user grouping, the complexity would be reduced and the interference mitigation would be more efficient for users having high interference. Therefore, how to provide a grouping method to achieve low complexity and low interference becomes critically important issue for the related industries and researchers.

### SUMMARY OF THE DISCLOSURE

The present disclosure has been accomplished in view of the above-noted circumstances. It is an objective of the present disclosure to provide a user grouping method and a base station, which assign users having high interference to same group in low complexity way to mitigate interference, and further adjust oversized or undersized groups, so as to reduce complexity and improve system performance greatly.

To achieve the above objective, the present disclosure provides a user grouping method, which can be adapted for a base station communicating with multiple user equipments (UEs) through multiple beams. The user grouping method includes the following steps. Whether beams used by the UEs are interfered with others are determined according to channel information of the UEs on each of the beams. The UEs having beams interfered with the others are assigned into same group. Numbers of users and used beams in at least one assigned group are adjusted.

The present disclosure further provides a base station communicating with a plurality of UEs through a plurality of beams. The base station includes a transmitting unit, a receiving unit and a processing unit. The transmitting unit is configured for transmitting data. The receiving unit is configured for receiving data. The processing unit is coupled to the transmitting unit and the receiving unit. The processing unit is configured at least but not limited for the following steps: whether beams used by the UEs are interfered with others are determined according to channel information of the UEs on each of the beams. The UEs having beams interfered with the others are assigned into same group. Numbers of users and used beams in at least one assigned group are adjusted.

When using the multi-stage user grouping method, the computational complexity would be reduced efficiently, so as to improve the system performance. Because UEs having high interference are assigned to the same group and the numbers of users and used beams in each group are limited, the complexities of subsequent precoding and multi-user detection can be reduced greatly.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a communication system according to a preferred embodiment of the present disclosure.

FIG. 2 is a block diagram of a base station according to the preferred embodiment of the present disclosure.

FIG. 3 is a block diagram of one of user equipments according to the preferred embodiment of the present disclosure.

FIG. 4 is a flow chart of a user grouping method according to the preferred embodiment of the present disclosure.

FIG. 5 is an example of the user grouping method at the first stage according to the preferred embodiment of the present disclosure, showing a beam set.

FIG. 6 is a flow chart of method 2-1.

FIG. 7 is a flow chart of method 2-2.

FIG. 8 is a flow chart of method 3-1.

FIG. 9 is a flow chart of method 3-2.

### DETAILED DESCRIPTION OF THE DISCLOSURE

Reference will now be made in detail to the present preferred embodiments of the disclosure, examples of which are illustrated in the accompanying drawings. Wherever possible, the same reference numbers are used in the drawings and the description to refer to the same or like parts.

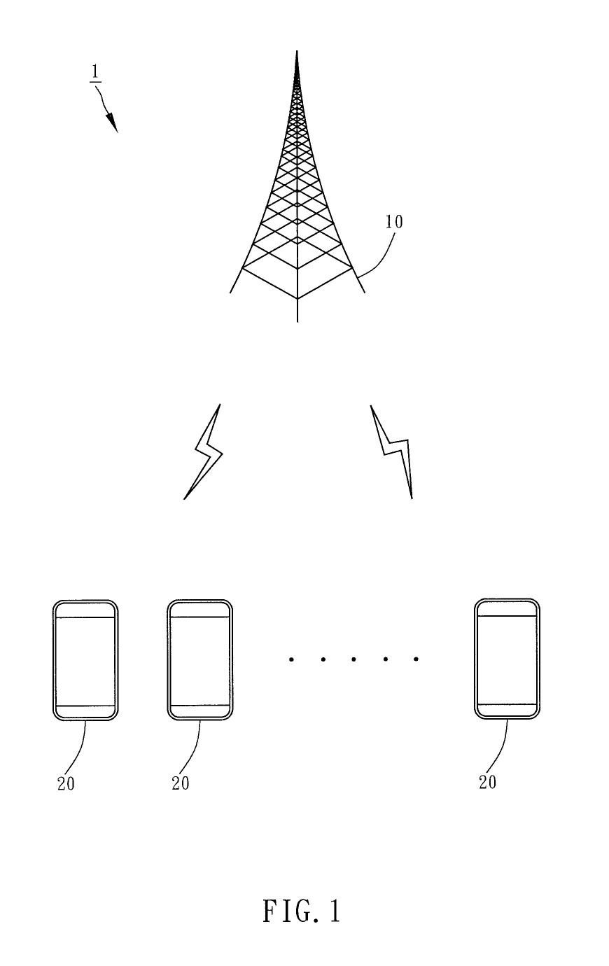

FIG. 1 illustrates a communication system 1 for multiple-input-multiple-output (MIMO) communication according to a preferred embodiment of the present disclosure. Referring to FIG. 1, the communication system 1 may include but not limited to a base station 10 and K user equipments (UEs) 20, where K is a positive integer. The communication system 1 is multiple user multiple input multiple output (MU-MIMO) communication system.

The term “base station” (BS) such as the BS 10 in this disclosure could represent various embodiments which for example could include but not limited to a Home Evolved Node B (HeNB), an eNB, an advanced base station (ABS), a base transceiver system (BTS), an access point, a home base station, a relay station, a scatterer, a repeater, an intermediate node, an intermediary, and/or satellite-based communication base stations.

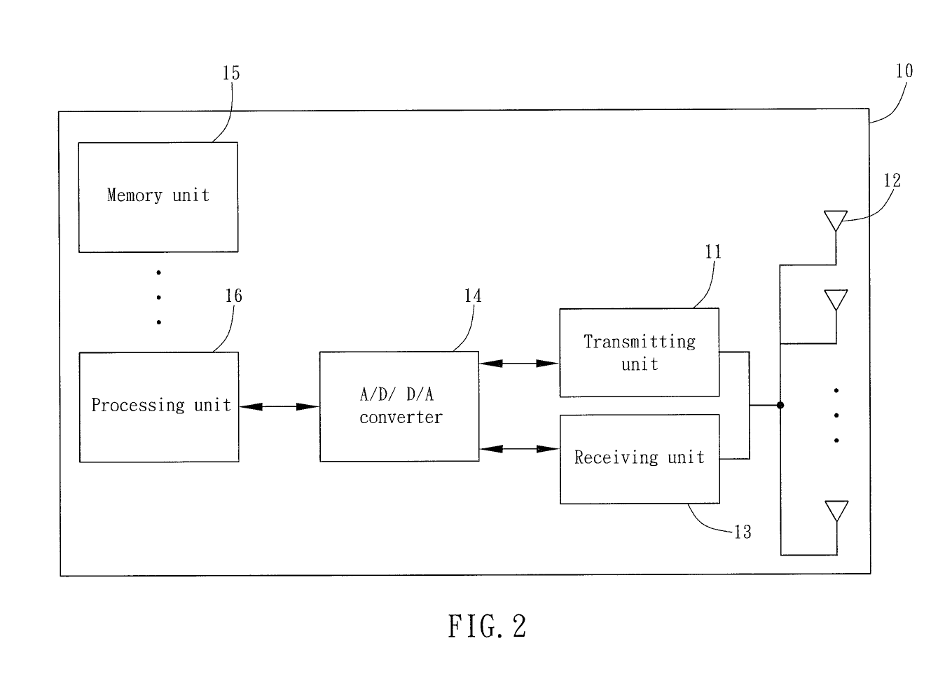

FIG. 2 is a block diagram of a base station 10 according to the preferred embodiment of the present disclosure, the BS 10 would include at least but not limited to a transmitting unit 11, multiple antennas 12, a receiving unit 13, an analog-to-digital (A/D)/digital-to-analog/(D/A) converter 14, a memory unit 15 and a processing unit 16. The transmitting unit 11 and the receiving unit 13 are used for transmitting and receiving modulated signals respectively, which could be wireless radio frequency (RF) signals through one or more antennas 12. The transmitting unit 11 and the receiving unit 13 may also perform operations such as low noise amplifying, impedance matching, frequency mixing, up or down frequency conversion, filtering, amplifying, and other related functions. The A/D and D/A converter 14 is configured to convert an analog signal format to a digital signal format during uplink communication and from a digital signal format to an analog signal format during downlink communication. The processing unit 16 is configured to process digital signal and to perform a proposed method (for example, beam-domain processing, beam-finding and tracking, channel estimation, user grouping, precoding and detection, etc.) described as follows in accordance with exemplary embodiments of the present disclosure. Also, the processing unit 16 may optionally be coupled to a non-transitory memory unit 15 (such as Erasable Programmable Read-Only Memory (EPROM), Electrically Erasable Programmable Read Only Memory (EEPROM) and cache memory, etc.) to store programming codes, configurations, buffering or permanent data, codebook, beambook, channel information (such as channel response or power gain), beam sets, and so forth. The functions of the processing unit 16 could be implemented by using programmable units such as a micro-processor, a micro-controller, a DSP chips, FPGA, etc. The functions of the processing unit 16 may also be implemented with separate electronic devices or ICs, and functions performed by the processing unit 16 may also be implemented within the domains of either hardware or software.

The term “user equipment” (UE) such as the UEs 20 in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, a mobile/portable communication device and so forth.

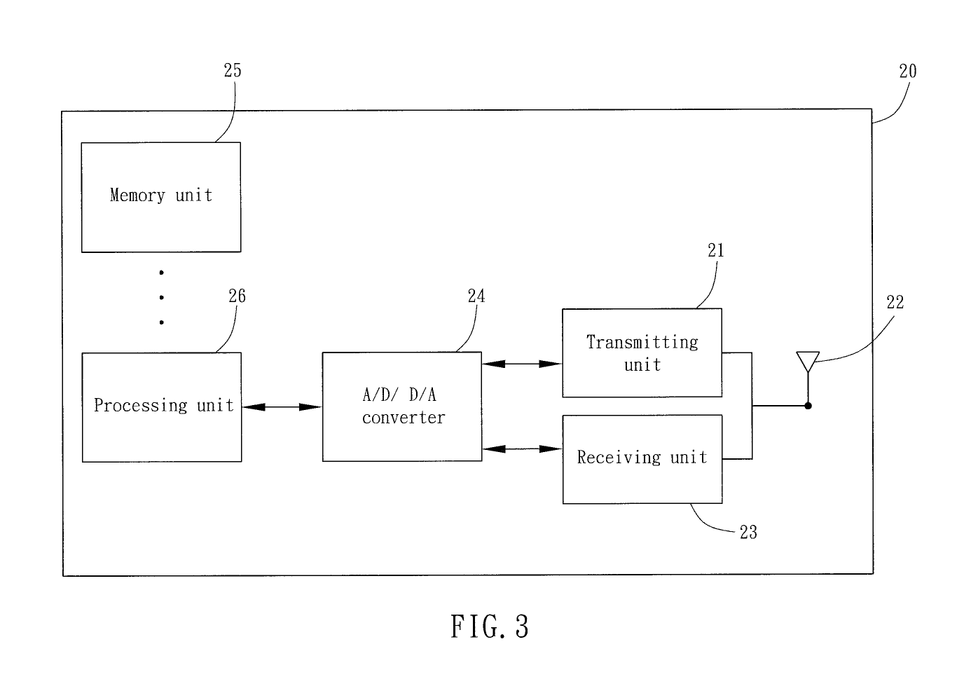

FIG. 3 is a block diagram of one of UEs 20 according to the preferred embodiment of the present disclosure. Each UE 20 may be represented by at least the functional elements as illustrated in FIG. 3 in accordance with an embodiment of the present disclosure. Each UE 20 would include at least but not limited to a transmitting unit 21, multiple antennas 22, a receiving unit 23, an analog-to-digital (A/D)/digital-to-analog/(D/A) converter 24, a memory unit 25 and a processing unit 26. The detailed description of functional elements of UE 20 may be referred to the description of functional elements of the BS 10 in FIG. 2, and therefore detailed descriptions for each element will not be repeated.

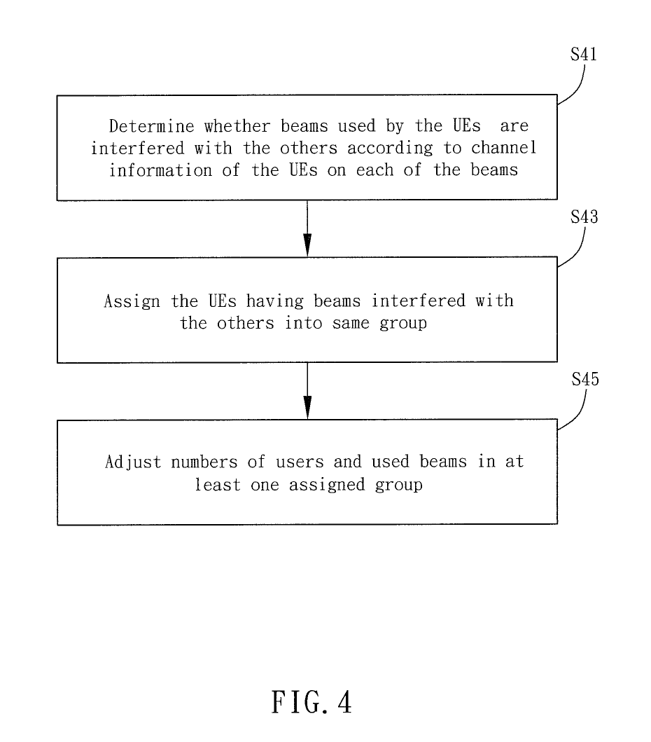

FIG. 4 is a flow chart of a user grouping method according to the preferred embodiment of the present disclosure. Referring to FIG. 4, the proposed method of the embodiment would be adapted for the BS 10 in FIG. 2. In the following, the proposed user grouping method would be introduced with each unit of the BS 10. The steps of the method can be modified according to actual implementation, and the invention is not limited thereto.

The most importance objective of the user grouping method is to improve the system performance and reduce the system computational complexity. In the following, the user grouping method, which is implemented by multi-stage, would be described in brief.

The First Stage:

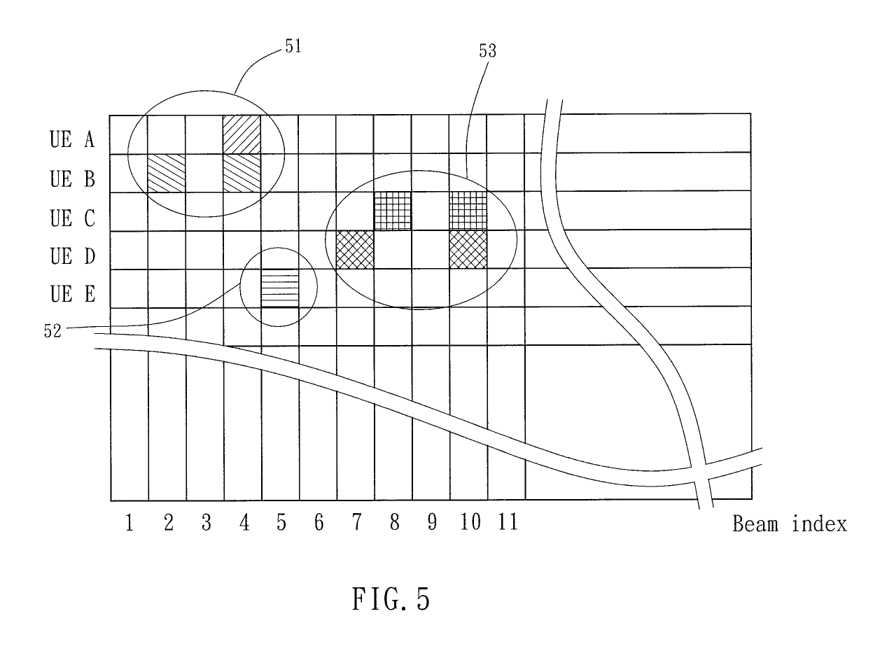

The BS 10 communicates with the UEs 20 through multiple beams, and the processing unit 16 can find the beams used by the UEs 20 (referred as detectable beams or used beams in the following) through the receiving unit 13 via the beam finding/tracking. There are lots of detectable beams, so the processing unit 16 can select some strongest detectable beams (maybe 5, 10, 15, etc. beams) to form a beam set. Referring to FIG. 5, which is an example of the user grouping method at the first stage. The processing unit 16 can select γ strongest beams used by each of the UEs 20 in power gain, where γ is a positive integer (γ is two as shown in FIG. 5, but γ can be modified in other embodiments). The processing unit 16 determines whether the γ strongest beams used by the UEs 20 are overlapped with beams of other UEs 20, to determine whether beams used by the UEs 20 are interfered with the others (step S41), namely, beams used by different UEs 20 being overlapped in the beam set 50 would be considered as being interfered with others. The processing unit 16 would assign the UEs 20 having the γ strongest beams overlapped (or interfered) with the others into same group (step S43). For example, UE A has a strongest beam, namely beam 4; UE B has two strongest beams, namely beams 2 and 4; the UEs A and B would be grouped into same group (group 51), the so on for groups 52 and 53.

It should be noticed that, the advantage of the user grouping method at the first stage is very low complexity, however, there are many other methods for determining whether the beams used by the UEs 20 are interfered with the others and can be applied on other embodiments, but the complexity should be noticed. In addition, the power gain (channel information) is used to determine the interference situation in this embodiment; however, in other embodiments, other types of channel information may be needed according to the modified determining method.

The grouping result of the first stage may form some oversized or undersized groups (according to the numbers of users and used beams) (the decision basis would be introduced as below), in order to achieve the objective to reduce the subsequent computational complexity, the processing unit 16 would adjust numbers of users and used beams in assigned group in the following stages (step S45).

The Second Stage

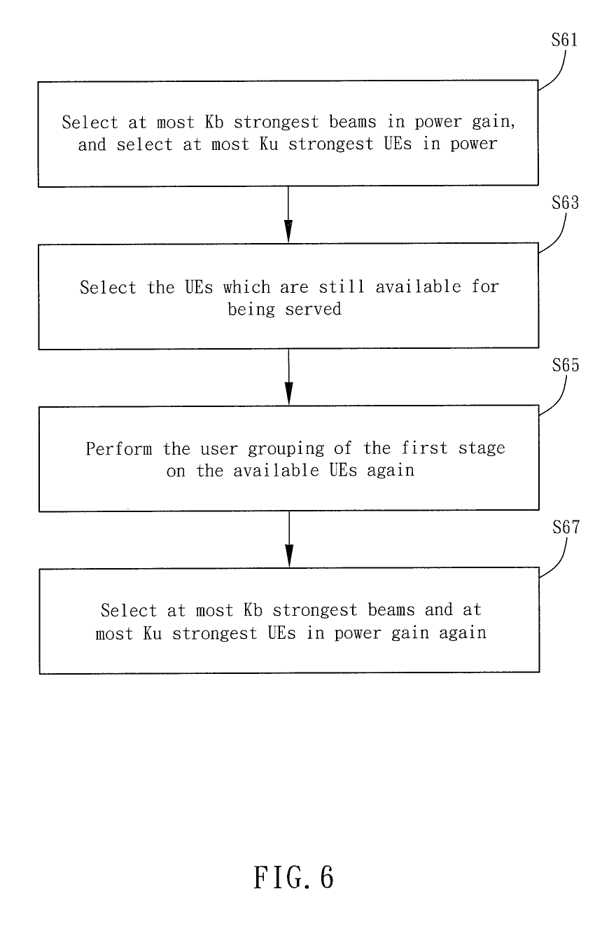

Two methods, methods 2-1 and 2-2, would be introduced at this stage, thereby removing the rest of beams and UEs 20. FIG. 6 is a flow chart of method 2-1. The processing unit 16 selects groups having number of users greater than a user upper limit (such as 5, 10, 15, etc.), and the processing unit 16 reduces the number of users in the selected groups (referred as oversized groups) according to the power gains of beams used by the UEs 20. The processing unit 16 selects, from each of the selected groups, at most K_{b} strongest beams in power gain, and selects, from each of the selected groups, at most Kᵤ strongest UEs 20 in power gain, where Kᵤ and K_{b} are positive integers (such as 10, 20, 30, etc.) (Step S61), then the UEs 20, which are not selected, would be removed from each of the selected groups. After the size of the group is limited, the processing unit 16 selects, from the removed UEs 20, the UEs 20 which are still available for being served (step S63), where K (such as 10, 20, 30, etc.) strongest beams of the available UEs 20 in power gain are not overlapped with the beam sets of the limited groups. Then, the processing unit 16 performs the user grouping of the first stage on the available UEs 20 again (step S65). If oversized groups (having the number of used beams exceeds K_{b} and the number of users exceeds Kᵤ) still exists in the processed groups, the processing unit 16 would select at most K_{b} strongest beams and at most Kᵤ strongest UEs 20 in power gain again (step S67).

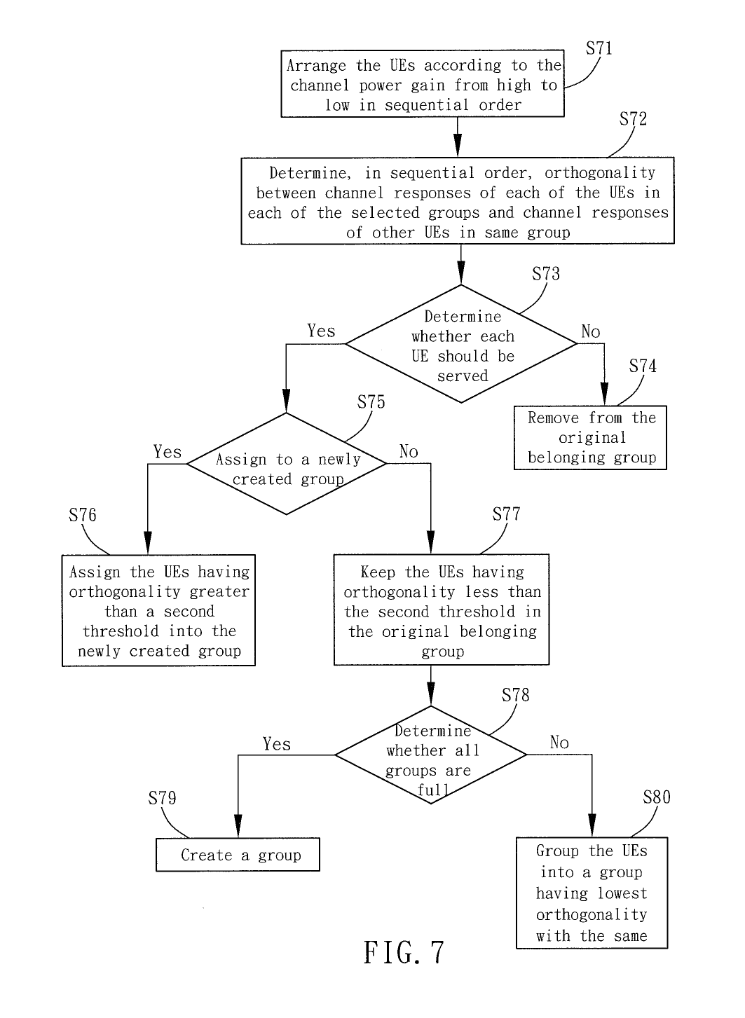

FIG. 7 is a flow chart of method 2-2. For the UEs 20 of the selected group (having the number of users is greater than the user upper limit), the processing unit 16 arranges the UEs 20 according to the channel power gain from high to low in sequential order (step S71); and the processing unit 16 determines, in sequential order, orthogonality between channel responses of each of the UEs 20 in each of the selected groups and channel responses of other UEs 20 in same group (step S72). The processing unit 16 projects channel response of each UE 20 to an orthogonal basis of the belonging group (i.e., performing gram-schmidt process on a vector space composed by channel response matrixes of all UEs 20 in the group to obtain the orthogonal basis), so as to obtain the projection of each UE 20. The processing unit 16 can determine whether each UE 20 should be served (step S73). If one of the UEs 20 has a small projection (less than a threshold), namely, the orthogonality between the said UE 20 and the belonging group thereof is high (for example, greater than a first threshold) (i.e., low interference), thus the said UE 20 can be served. If another UE 20 has large projection (greater than another threshold), namely, the orthogonality between the said UE 20 and the belonging group thereof is low (for example, less than the first threshold) (i.e., high interference), thus the said UE 20 cannot be served and would be removed from the original belonging group (step S74). Then, the processing unit 16 determines whether to assign one of the UEs 20 to a newly created group (step S75). The processing unit 16 assigns the UEs 20 having orthogonality greater than a second threshold into the newly created group (step S76), and keeps the UEs 20 having orthogonality less than the second threshold in the original belonging group (step S77), and the second threshold is greater than the first threshold. If the newly created group is not created, the processing unit 16 may further determine whether all groups are full (step S78). If all existing groups are full, a newly created group would be created (step S79). If all of the group are not full, the UEs 20 would be grouped into a group having lowest orthogonality with the same (step S80). It should be noticed that, before one of the UEs 20 is grouped into the existing groups, the processing unit 16 may check the limitation of K_{b} used beams and Kᵤ users, the UEs 20 would be grouped into the existing group if satisfying the limitation.

It means that, the BS 10 would remove, from the original belonging group, the UEs 20 having high interference; if one UE 20 is not interfered with the others in the existing group, a newly created group would be created. If the newly created group are not created, the BS 10 would assign the UE 20 into an existing group having highest interference with the said UE 20, to ensure that interference between each two UEs 20 can be reduced during precoding.

The Third Stage

In this stage, the undersized groups at the first stage are combined. The processing unit 16 selects group having the number of users less than a user lower limit (for example, 1, 3, 5, etc.) (referred as undersized group), and combines part of the selected groups, so as to mitigate interference efficiently during the subsequent preceding and improve the system performance. Two methods, methods 3-1 and 3-2, would be introduced as below.

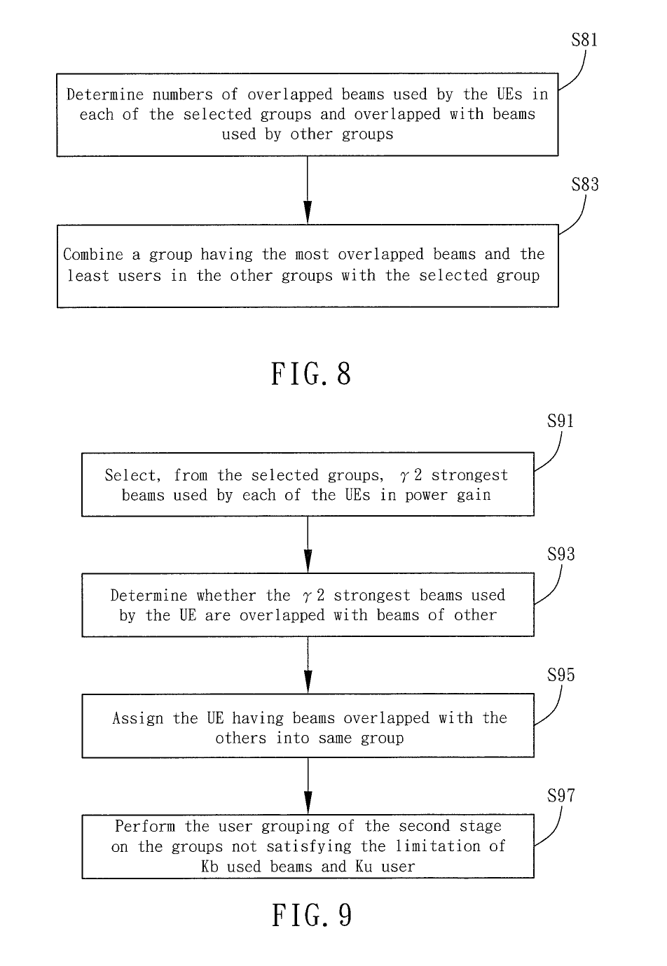

FIG. 8 is a flow chart of method 3-1. The processing unit 16 determines numbers of overlapped beams used by the UEs 20 in each of the selected groups (undersized groups) and overlapped with beams used by other groups (step S81), and combines a group having the most overlapped beams and the least users in the other groups with the selected group (step S83). It should be noticed that, before the combination of the two groups, the processing unit 16 may further determine whether the combined group satisfies the limitation of K_{b} used beams and K users (the numbers of used beams and users in the combined group do not exceed K_{b} and Kᵤ, respectively), combine the groups if satisfying the limitation, and not combine the groups if not satisfying the limitation.

It should be noticed that, in the method 3-1, combing the group having the most overlapped beams and the least users is to reduce the computational complexity; however, in other embodiments, the processing unit 16 also can select the group having the number of overlapped beams exceeding an overlapped threshold (for example, 3, 5, 7, etc.) and/or the number of users less than a number threshold to combine.

FIG. 9 is a flow chart of method 3-2 which performs the user grouping of the first stage again. The processing unit 16 selects, from the selected groups (undersized groups), γ2 strongest beams used by each of the UEs 20 in power gain (step S91), and determines whether the γ2 strongest beams used by the UE 20 are overlapped with beams of other UEs 20 (step S93). The processing unit 16 would assign the UE 20 having beams overlapped (or interfered) with the others into same group (step S95), and the processing unit 16 performs the user grouping of the second stage on the groups not satisfying the limitation of K_{b} used beams and Kᵤ users (step S97). It should be noticed that, in this stage, γ2 is a positive integer greater than γ, so as to increase the probability to combine the groups, and increase number of users in the group; however, in other embodiments, the relation between γ and γ2 can be modified depending on requirement.

It should be noticed that, either methods 3-1 and 3-2 of the third stage can be selected to apply on the proposed user grouping method; however, there are many other methods for re-assigning the undersized groups, which can be applied on other embodiments. In addition, the user grouping of the third stage may facilitate the interference mitigation efficiently during the subsequent precoding; however, if the computational complexity need to be reduced, the user grouping of the third stage can be omitted.

In conclusion, the proposed multi-stage user grouping method of the present disclosure can reduce the computational complexity efficiently, and after using the proposed user grouping method, the interference between different groups is low, thus the groups can use the same time/frequency resources. It means that, the proposed user grouping method is one of important factors to affect the computational complexity. In addition, the numbers of users and used beams in each group satisfy the limitation of K_{b} used beams and Kᵤ users, so that the BS 10 has enough resource to apply precoding, interference mitigation or user scheduling process with higher complexity.

The above description represents merely the preferred embodiment of the present disclosure, without any intention to limit the scope of the present disclosure. The simple variations and modifications not to be regarded as a departure from the spirit of the disclosure are intended to be included within the scope of the following claims.

What is claimed is:

1. A user grouping method, adapted for a base station communicating with a plurality of user equipments (UEs) through a plurality of beams, the user grouping method comprising:
determining whether beams used by the UEs are interfered with others according to channel information of the UEs on each of the beams;
assigning the UEs having beams interfered with the others into same group; and
adjusting numbers of users and used beams in at least one assigned group.

2. The user grouping method as claimed in claim 1, wherein the channel information comprises power gain, and determining whether the beams used by the user equipment are interfered with the others comprises:
selecting γ strongest beams used by each of the UEs in power gain, wherein γ is a positive integer; and
determining whether the γ strongest beams used by the UEs are overlapped with others.

3. The user grouping method as claimed in claim 2, wherein assigning the UEs having beams interfered with the others into the same group comprises:
assigning the UEs having the γ strongest beams overlapped with the others into the same group.

4. The user grouping method as claimed in claim 1, wherein the channel information comprises power gain, and adjusting the numbers of users and used beams in the at least one assigned group comprises:
selecting groups having the number of users greater than a user upper limit; and
reducing the number of users in the selected groups according to the power gains of beams used by the UEs.

5. The user grouping method as claimed in claim 4, wherein reducing the number of users in the selected groups comprises:
selecting, from each of the selected groups, at most K_{b} strongest beams in power gain, wherein K_{b} is a positive integer;
selecting, from each of the selected groups, at most Kᵤ strongest UEs in power gain, wherein Kᵤ is a positive integer; and
removing, from each of the selected groups, the UEs which are not selected.

6. The user grouping method as claimed in claim 4, wherein the channel information comprises channel response, and reducing the number of users in the selected groups comprises:
determining, in sequential order, orthogonality between channel responses of each of the UEs in each of the selected groups and channel responses of other UEs in same group; and
removing, from each of the selected groups, the UEs having orthogonality less than a first threshold.

7. The user grouping method as claimed in claim 6, wherein after removing the UEs having orthogonality less than the first threshold from each of the selected groups, the user grouping method further comprises:
assigning the UEs having orthogonality greater than a second threshold into a newly created group, wherein the second threshold is greater than the first threshold.

8. The user grouping method as claimed in claim 1, wherein adjusting the numbers of users and used beams in the at least one assigned group comprises:
selecting group having the number of users less than a user lower limit; and
combining part of the selected groups.

9. The user grouping method as claimed in claim 8, wherein combining part of the selected groups comprises:
determining numbers of overlapped beams used by the UEs in each of the selected groups and overlapped with beams used by other groups; and
combining a group having the most overlapped beams and the least users in the other groups with the selected group.

10. A base station, communicating with a plurality of UEs through a plurality of beams, the base station comprising:
a transmitting unit, used for transmitting data;
a receiving unit, used for receiving data; and
a processing unit, coupled with the transmitting unit and the receiving unit, and the processing unit being configured for:
determining whether beams used by the UEs are interfered with others according to channel information of the UEs on each of the beams;
assigning the UEs having beams interfered with the others into same group; and
adjusting numbers of users and used beams in at least one assigned group.

11. The base station as claimed in claim 10, wherein the channel information comprises power gain, and the processing unit is configured for:
selecting γ strongest beams used by each of the UEs in power gain, wherein γ is a positive integer, and
determining whether the γ strongest beams used by the UEs are overlapped with others.

12. The base station as claimed in claim 11, wherein the processing module is configured at least for:
assigning the UEs having the γ strongest beams overlapped with the others into the same group.

13. The base station as claimed in claim 10, wherein the channel information comprises power gain, and the processing module is configured at least for:
selecting groups having number of users greater than a user upper limit; and
reducing the number of users in the selected groups according to the power gains of beams used by the UEs.

14. The base station as claimed in claim 13, wherein the processing module is configured at least for:
selecting, from each of the selected groups, at most K_{b} strongest beams in power gain, wherein K_{b} is a positive integer;
selecting, from each of the selected groups, at most Kᵤ strongest UEs in power gain, wherein Kᵤ is a positive integer, and
removing, from each of the selected groups, the UEs which are not selected.

15. The base station as claimed in claim 13, wherein the processing module is configured at least for:
determining, in sequential order, orthogonality between channel responses of each of the UEs in each of the selected groups and channel responses of other UEs in same group; and
removing, from each of the selected groups, the UEs having orthogonality less than a first threshold.

16. The base station as claimed in claim 15, wherein the processing module is configured at least for:
assigning the UEs having orthogonality greater than a second threshold into a newly created group, wherein the second threshold is greater than the first threshold.

17. The base station as claimed in claim 10, wherein the processing module is configured at least for:
selecting group having user number less than a user lower limit; and
combining part of the selected groups.

18. The base station as claimed in claim 17, wherein the processing module is configured at least for:
determining numbers of overlapped beams used by the UEs in each of the selected groups and overlapped with beams used by other groups; and
combining a groups having the most overlapped beams and the least users in the other groups with the selected group.
